(19) United States
(12) Patent Application Publication
(10) Pub. No.: US 2026/0292294 A1
(43) Pub. Date: Sep. 24, 2026

(54) DATA PROCESSING METHOD AND DATA PROCESSING APPARATUS

(71) Applicant: ANYPOINT MEDIA CO., LTD., Seoul (KR)

(72) Inventors: Wonjang BAEK, Seongnam-si (KR); Doohwan LEE, Seoul (KR)

(73) Assignee: ANYPOINT MEDIA CO., LTD., Seoul (KR)

(21) Appl. No.: 19/684,638

(22) Filed: May 21, 2026

Related U.S. Application Data
(63) Continuation of application No. PCT/KR2024/018657, filed on Nov. 22, 2024.

(30) Foreign Application Priority Data
Nov. 27, 2023 (KR) 10-2023-0166280

(51) Int. Cl. H04N 21/436; H04N 21/41; H04N 21/435; H04N 21/442

(52) U.S. Cl. CPC H04N 21/43615; H04N 21/4126; H04N 21/435; H04N 21/44227

(57) ABSTRACT

According to one aspect of the technique of the present disclosure, a data processing method to be performed by a data processing apparatus process is provided. The method includes: (a) receiving, from a content playback apparatus, first metadata pre-designated for first content data that is signal-processed and played back by the content playback apparatus; (b) determining whether the content playback apparatus and a user apparatus are included in a same network group; (c) generating, based on the first metadata, second metadata including at least information of an operation to be performed by the user apparatus in association with the first content data in case it is determined in (b) that the content playback apparatus and the user apparatus are included in the same network group; and (d) transmitting the second metadata to the user apparatus. Further, the first metadata includes at least identification information of the operation information.

### CROSS-REFERENCE TO RELATED PATENT APPLICATION

This non-provisional U.S. patent application is a bypass continuation application of PCT International Application No. PCT/KR2024/018657, filed on Nov. 22, 2024, in the WIPO, the international application being based upon and claiming the benefit of priority from Korean Patent Application No. 10-2023-0166280, filed on Nov. 27, 2023, in the Korean Intellectual Property Office, the entire contents of which are hereby incorporated by reference.

### BACKGROUND

### 1. Field

The present disclosure relates to a data processing method and a data processing apparatus, and more particularly, to a data processing method and a data processing apparatus for generating metadata associated with content played back by a content playback apparatus and providing the metadata to a user apparatus.

### 2. Related Art

Techniques have been developed and implemented for providing, through a user apparatus such as a smart phone or a tablet computer, information related to content being played back by a content playback apparatus such as a set-top box, a digital television, or a personal computer.

For example, Korean Registered Patent No. 10-1716617 (Patent Document 1) discloses a technique using augmented reality to enable a viewer (user) of home shopping content to receive various kinds of information associated with the home shopping content through a user apparatus while the home shopping content is being played back by a content playback apparatus. Specifically, an augmented reality server provides augmented reality content related to the home shopping content, and an augmented reality application executed on the user apparatus of the user receives the augmented reality content from the augmented reality server based on a captured image of a screen displaying the home shopping content, the image being captured through the user apparatus.

However, application of the technique disclosed in Korean Registered Patent No. 10-1716617 requires separate production of augmented reality content associated with home shopping content, thereby increasing the time and cost required to provide various types of information associated with the home shopping content.

Further, from the user's perspective, in order to receive various types of information associated with the home shopping content, the user is required to perform complicated operations such as executing an augmented reality application and capturing an image of a screen displaying the home shopping content.

Accordingly, there is an increasing demand for a technique capable of conveniently providing, through a user apparatus, various types of information related to content being played back by a content playback apparatus.

### RELATED ART

### Patent Document

Patent Document 1: Korean Registered Patent No. 10-1716617.

### SUMMARY

It is an object of the technique of the present disclosure to provide a data processing method and a data processing apparatus for generating, based on first metadata designated for first content data that is signal-processed and played back by a content playback apparatus, second metadata including at least operation information indicating an operation to be performed by a user apparatus, and transmitting the second metadata to the user apparatus.

According to one aspect of the technique of the present disclosure, there is provided a data processing method to be performed by a data processing apparatus, the method including:
(a) receiving, from a content playback apparatus, first metadata pre-designated for first content data that is signal-processed and played back by the content playback apparatus; (b) determining whether the content playback apparatus and a user apparatus are included in a same network group; (c) generating, based on the first metadata, second metadata including at least operation information indicating an operation to be performed by the user apparatus in association with the first content data in case it is determined in (b) that the content playback apparatus and the user apparatus are included in the same network group; and (d) transmitting the second metadata to the user apparatus, wherein the first metadata includes at least identification information of the operation information.

According to another aspect of the technique of the present disclosure, there is provided a data processing apparatus including a processing circuitry configured to perform: (a) receiving, from a content playback apparatus, first metadata pre-designated for first content data that is signal-processed and played back by the content playback apparatus; (b) determining whether the content playback apparatus and a user apparatus are included in a same network group; (c) generating, based on the first metadata, second metadata including at least operation information indicating an operation to be performed by the user apparatus in association with the first content data in case it is determined in (b) that the content playback apparatus and the user apparatus are included in the same network group; and (d) transmitting the second metadata to the user apparatus, wherein the first metadata includes at least identification information of the operation information.

According to the technique of the present disclosure, second metadata including at least operation information indicating an operation to be performed by a user apparatus may be generated based on first metadata designated for first content data that is signal-processed and played back by a content playback apparatus, and the generated second metadata may be transmitted to the user apparatus. Accordingly, without requiring complicated operations, information associated with the first content data being played back by the content playback apparatus may be conveniently provided to a user through the user apparatus based on the second metadata. For example, the user may easily identify and purchase a product designated for the first content data through the user apparatus based on the second metadata, or may easily install, on the user apparatus, an application designated for the first content data based on the second metadata. That is, according to the technique of the present disclosure, operations to be performed by the user apparatus, for example, provision of product information or provision of second content data, may be more specifically controlled in terms of which application is used or which application is installed.

### BRIEF DESCRIPTION OF THE DRAWINGS

FIG. 1 is a flowchart schematically illustrating an example of a data processing method according to a first embodiment of the technique of the present disclosure.

FIG. 2 is a diagram schematically illustrating a configuration of a data processing apparatus, which is configured to perform the data processing method according to the first embodiment of the technique of the present disclosure.

FIG. 3 is a diagram schematically illustrating an environment in which the data processing apparatus, which is configured to perform the data processing method according to the first embodiment of the technique of the present disclosure, is disposed.

FIG. 4 is a diagram schematically illustrating an example of first metadata in the data processing method according to the first embodiment of the technique of the present disclosure.

FIG. 5 is a diagram schematically illustrating an example of a process for determining whether a content playback apparatus and a user apparatus belong to the same network group in the data processing method according to the first embodiment of the technique of the present disclosure.

FIG. 6 is a diagram schematically illustrating an example of second metadata in the data processing method according to the first embodiment of the technique of the present disclosure.

FIG. 7 is a diagram schematically illustrating an example of operation information in the data processing method according to the first embodiment of the technique of the present disclosure.

FIG. 8 is a diagram schematically illustrating an example of a data processing method according to a second embodiment of the technique of the present disclosure.

### DETAILED DESCRIPTION

Hereinafter, embodiments of a data processing method and a data processing apparatus according to the technique of the present disclosure will be described mainly with reference to the drawings. Meanwhile, in the drawings for describing the embodiments of the technique of the present disclosure, for the sake of convenience of description, only a part of the practical configurations may be illustrated or the practical configurations may be illustrated while a part of the practical configurations is omitted or changed. Further, relative dimensions and proportions of parts therein may be exaggerated or reduced in size.

### First Embodiment

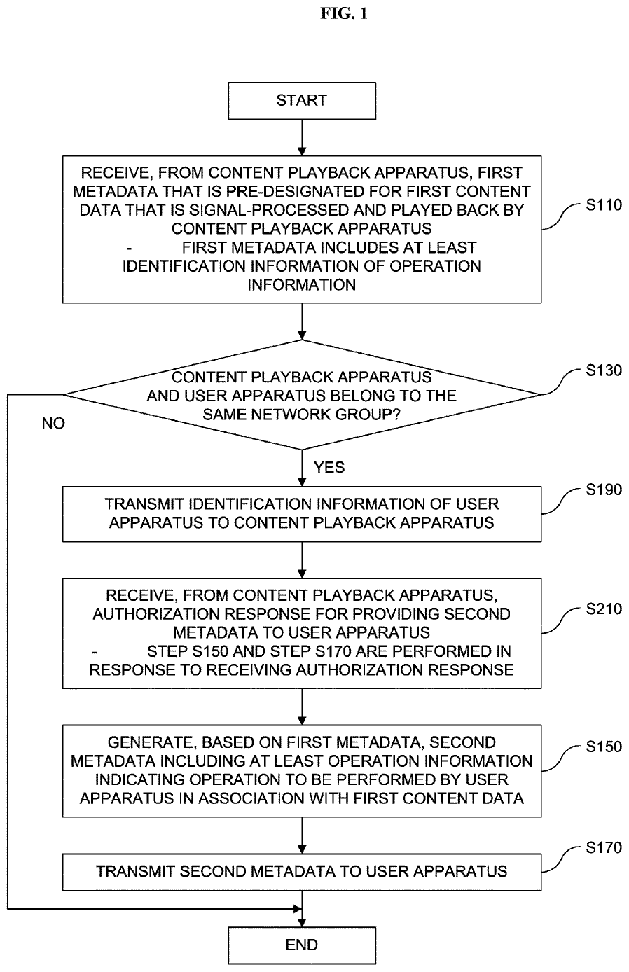

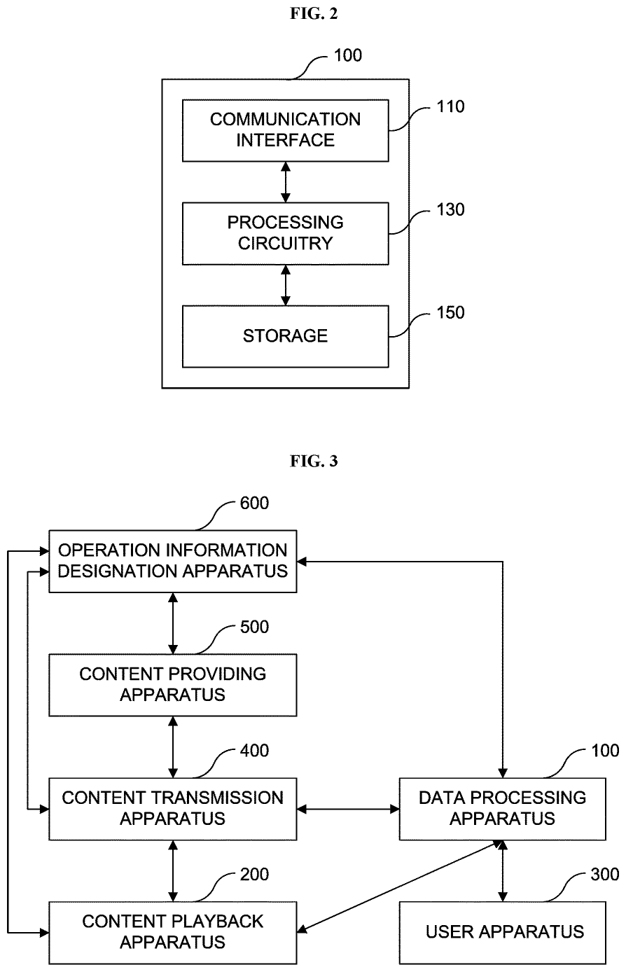

FIG. 1 is a flowchart schematically illustrating an example of a data processing method according to a first embodiment of the technique of the present disclosure. FIG. 2 is a diagram schematically illustrating a configuration of a data processing apparatus, which is configured to perform the data processing method according to the first embodiment of the technique of the present disclosure. FIG. 3 is a diagram schematically illustrating an environment in which the data processing apparatus, which is configured to perform the data processing method according to the first embodiment of the technique of the present disclosure, is disposed.

A data processing apparatus 100 configured to perform the data processing method according to the first embodiment of the technique of the present disclosure will first be described with reference to FIG. 2.

As shown in FIG. 2, the data processing apparatus 100 configured to perform the data processing method according to the first embodiment of the technique of the present disclosure may include a communication interface 110, a processing circuitry 130, and a storage 150.

The communication interface 110 may communicate with other apparatuses, such as a content playback apparatus 200 and a user apparatus 300 shown in FIG. 3, using wired and/or wireless communication schemes. The communication interface 110 may be implemented by a semiconductor device, such as a communication chip.

The processing circuitry 130 may be implemented by one or more semiconductor devices, such as a central processor (CPU), a graphics processor (GPU), and/or an application specific integrated circuit (ASIC).

The processing circuitry 130 may be implemented using, for example, a plurality of semiconductor devices. For example, the processing circuitry 130 may include a first semiconductor device configured to perform a communication function and a second semiconductor device configured to perform data processing.

The processing circuitry 130 may perform the data processing method according to the first embodiment, and may control the communication interface 110 and the storage 150 to perform the data processing method according to the first embodiment.

The storage 150 is configured to store data and may be implemented by a semiconductor device, such as a semiconductor memory. For example, the storage 150 may store operation information to be described later. The storage 150 may also be implemented using a plurality of semiconductor devices.

Next, an environment in which the data processing apparatus 100 is disposed will be described with reference to FIG. 3.

As shown in FIG. 3, the data processing apparatus 100 may be communicatively connected to the content playback apparatus 200 and the user apparatus 300 through a communication network. The data processing apparatus 100 may also be communicatively connected to a content transmission apparatus 400 and an operation information designation apparatus 600 through the communication network.

The content playback apparatus 200 may be configured to receive content from the content transmission apparatus 400 through a broadcast network and/or a communication network, perform signal processing on the content, and provide the processed content for display. The content playback apparatus 200 may include, for example, a digital television, a personal computer, and a set-top box. In other words, the content playback apparatus 200 may include not only a digital television or a set-top box configured to receive content transmitted in a broadcast format and perform signal processing on the content to provide the signal-processed content to an end user, but also a computing apparatus capable of executing an application that receive content through a communication network and perform signal processing on the content to provide the signal-processed content to an end user. The content playback apparatus 200 may include, for example, a connected TV (CTV) and an addressable TV (ATV).

The user apparatus 300 may be a portable computing apparatus. The user apparatus 300 may include, for example, a smart phone and a tablet computer.

The content transmission apparatus 400 may be configured to transmit content to the content playback apparatus 200 through a broadcast network or a communication network. The content transmission apparatus 400 may be implemented using, for example, a plurality of apparatuses.

A content providing apparatus 500 may be configured to provide content to the content transmission apparatus 400.

The operation information designation apparatus 600 may be configured to set operation information to be described later. At least a portion of the operation information set by the operation information designation apparatus 600 may be transmitted to the content playback apparatus 200 via the content providing apparatus 500 and the content transmission apparatus 400, or via the content transmission apparatus 400. The operation information may also be transmitted to the data processing apparatus 100.

The data processing apparatus 100, the content transmission apparatus 400, the content providing apparatus 500, and the operation information designation apparatus 600 may be operated by the same entity, or may be operated by different entities.

For example, in the case of a digital cable broadcasting service or an over-the-top (OTT) media service, the content transmission apparatus 400 may be operated by a system operator (SO), and the content providing apparatus 500 may be operated by a program provider (PP). The operation information designation apparatus 600 may be operated by the SO, the PP, or another third party. The PP may also be referred to as a content provider (CP).

The content playback apparatus 200, the user apparatus 300, and the content transmission apparatus 400 may be configured to perform processing associated with the data processing method according to the first embodiment of the technique of the present disclosure.

For example, the content playback apparatus 200 may be configured to transmit first metadata to be described later to the data processing apparatus 100, and may also be configured to transmit an authorization response to the data processing apparatus 100.

Further, for example, the user apparatus 300 may be configured to perform an operation corresponding to operation information to be described later, and to transmit execution information indicating a result of the performed operation to the data processing apparatus 100.

In addition, for example, the content transmission apparatus 400 may be configured to transmit, together with first content data to be described later, at least identification information of the operation information to the content playback apparatus 200.

Hereinafter, the data processing method according to the first embodiment of the technique of the present disclosure will be described in more detail with reference to FIG. 1.

Referring to FIG. 1, first, the data processing apparatus 100, and more particularly, the processing circuitry 130, receives, from the content playback apparatus 200, first metadata that is pre-designated for first content data that is signal-processed and played back by the content playback apparatus 200 (Step S110).

The first content data may refer to, for example, advertisement content data. Alternatively, the first content data may refer to, for example, a portion of content. For example, in a case where the content has a duration of 40 minutes, data corresponding to a portion of the content may be referred to as the first content data.

Preferably, the content playback apparatus 200 may transmit the first metadata to the data processing apparatus 100 at a time when playback of the first content data starts, and the processing circuitry 130 receives the first metadata.

The first metadata may include at least identification information of operation information to be described later.

The identification information of the operation information is unique information assigned to the operation information. For example, the identification information of the operation information may be assigned by the above-described operation information designation apparatus 600.

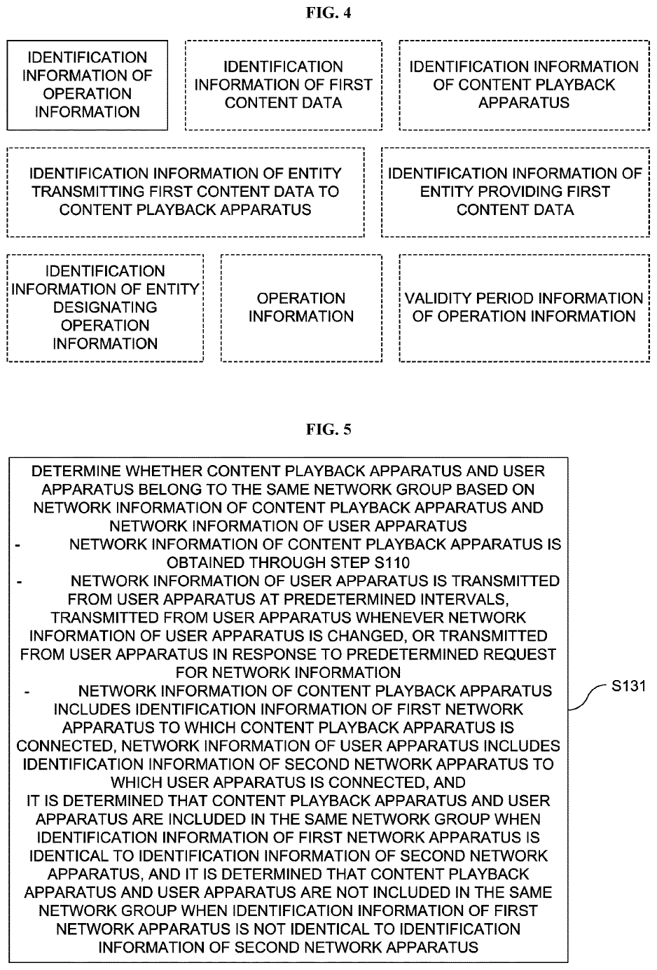

FIG. 4 is a diagram schematically illustrating an example of first metadata in the data processing method according to the first embodiment of the technique of the present disclosure.

In FIG. 4, solid lines indicate mandatory information that is required to be included (i.e., in the example of FIG. 4, identification information of operation information), and dashed lines indicate optional information that may be additionally included.

Referring to FIG. 4, the first metadata may include at least identification information of operation information. The first metadata may further include one or more of identification information of the first content data, identification information of the content playback apparatus 200, identification information of an entity transmitting the first content data to the content playback apparatus 200, identification information of an entity providing the first content data, identification information of an entity designating the operation information, the operation information, and validity period information of the operation information.

The identification information of the first content data is unique information assigned to the first content data.

The identification information of the content playback apparatus 200 is unique information assigned to the content playback apparatus 200, and may include, for example, network information of the content playback apparatus 200 (e.g., an IP address) and/or apparatus identification information thereof.

The identification information of the entity transmitting the first content data to the content playback apparatus 200 may include, for example, identification information of an entity operating the above-described content transmission apparatus 400 (e.g., broadcast station identification information).

The identification information of the entity providing the first content data may include, for example, identification information of an entity operating the above-described content providing apparatus 500 (e.g., channel identification information).

The identification information of the entity designating the operation information may include, for example, identification information of an entity that designates the operation information using the above-described operation information designation apparatus 600. For example, in a case where the first content data is advertisement content and an advertiser designates the operation information, the identification information may correspond to identification information of the advertiser.

The validity period information of the operation information may indicate a period during which the above-described operation information is valid, and may be set, for example, in association with the first content data, or may be set to a predetermined period such as 30 minutes or one day. The various pieces of information described above may be used as reference information in a case where, for example, the user apparatus 300 generates execution information to be described later. In addition, the various pieces of information described above may also be used as reference information in a case where, for example, the data processing apparatus 100 transmits execution information, to be described later, to any one of the content transmission apparatus 400, the content providing apparatus 500, and the operation information designation apparatus 600.

The operation information will be described later in detail.

The content transmission apparatus 400 may transmit, together with the first content data, only the identification information of the above-described operation information to the content playback apparatus 200. Alternatively, the content transmission apparatus 400 may transmit, to the content playback apparatus 200, the first content data together with one or more of identification information of the first content data, identification information of the content playback apparatus 200, identification information of an entity transmitting the first content data to the content playback apparatus 200, identification information of an entity providing the first content data, identification information of an entity designating the operation information, the operation information, and validity period information of the operation information.

In a case where the content playback apparatus 200 plays back the first content data, the content playback apparatus 200 may transmit, to the data processing apparatus 100, only the identification information of the operation information as the first metadata, or may transmit, to the data processing apparatus 100, first metadata further including at least one of the various pieces of information described above. The content playback apparatus 200 may directly acquire one or more of the various pieces of information described above to generate the first metadata. For example, the content playback apparatus 200 may directly acquire various information such as identification information of the first content data, identification information of the content playback apparatus 200, identification information of an entity transmitting the first content data to the content playback apparatus 200, and identification information of an entity providing the first content data, and may generate the first metadata based thereon.

Referring back to FIG. 1, in step S130, the processing circuitry 130 may determine whether the content playback apparatus 200 and the user apparatus 300 belong to the same network group.

FIG. 5 is a diagram schematically illustrating an example of a process for determining whether the content playback apparatus 200 and the user apparatus 300 belong to the same network group in the data processing method according to the first embodiment of the technique of the present disclosure.

Referring to FIG. 5, Step S130 May Include Step S131.

In step S131, the processing circuitry 130 may determine whether the content playback apparatus 200 and the user apparatus 300 belong to the same network group based on network information of the content playback apparatus 200 and network information of the user apparatus 300.

The network information of the content playback apparatus 200 may be obtained, for example, through step S110 described above. Alternatively, the network information of the content playback apparatus 200 may be received in advance from the content playback apparatus 200 and stored in the data processing apparatus 100. For example, the network information of the content playback apparatus 200 may be stored, for example, in the storage 150.

For example, the network information of the user apparatus 300 may be transmitted from the user apparatus 300 at predetermined intervals (e.g., every day). In this case, the data processing apparatus 100 may store the network information of the user apparatus 300, which is transmitted at the predetermined intervals, e.g., in the storage 150.

Alternatively, for example, the network information of the user apparatus 300 may be changed depending on whether the user apparatus 300 is connected to a mobile communication network, such as 5G, or to a wireless communication network, such as Wi-Fi. In this case, the user apparatus 300 may transmit the network information of the user apparatus 300 to the data processing apparatus 100, and the data processing apparatus 100 may store the network information of the user apparatus 300, for example, in the storage 150.

Alternatively, for example, the data processing apparatus 100 may transmit a request for network information to the user apparatus 300, and the user apparatus 300 may transmit network information of the user apparatus 300 to the data processing apparatus 100 in response to the request for network information. In this case, the data processing apparatus 100 may store the network information of the user apparatus 300, for example, in the storage 150.

The network information of the content playback apparatus 200 and the network information of the user apparatus 300 may include, for example, IP addresses.

For example, the network information of the content playback apparatus 200 may include identification information of a first network apparatus that is connected to the content playback apparatus 200, and the network information of the user apparatus 300 may include identification information of a second network apparatus that is connected to the user apparatus 300. In a case where the identification information of the first network apparatus is identical to the identification information of the second network apparatus, the processing circuitry 130 may determine that the content playback apparatus 200 and the user apparatus 300 belong to the same network group. On the other hand, in a case where the identification information of the first network apparatus is different from the identification information of the second network apparatus, the processing circuitry 130 may determine that the content playback apparatus 200 and the user apparatus 300 do not belong to the same network group. In other words, in a case where the content playback apparatus 200 and the user apparatus 300 are connected to the same network access apparatus, the processing circuitry 130 may determine that the content playback apparatus 200 and the user apparatus 300 belong to the same network group.

More specifically, in a case where the content playback apparatus 200 and the user apparatus 300 are connected to the same access point (AP), an IP address of the content playback apparatus 200 and an IP address of the user apparatus 300 may be externally recognized as the same IP address corresponding to the AP. Accordingly, in a case where the IP address of the content playback apparatus 200 is identical to the IP address of the user apparatus 300, it may be determined that the content playback apparatus 200 and the user apparatus 300 belong to the same network group, that is, are connected to the same AP.

Although the present embodiment is described based on an example in which step S130 is performed after step S110, step S130 may alternatively be performed before step S110.

Referring back to FIG. 1, in step S150, in a case where it is determined in step S130 that the content playback apparatus 200 and the user apparatus 300 belong to the same network group, the processing circuitry 130 may generate second metadata based on the first metadata. The second metadata includes at least operation information indicating an operation to be performed by the user apparatus 300 in association with the first content data.

On the other hand, in a case where it is determined in step S130 that the content playback apparatus 200 and the user apparatus 300 do not belong to the same network group, the processing circuitry 130 may terminate execution of the data processing method according to the present embodiment.

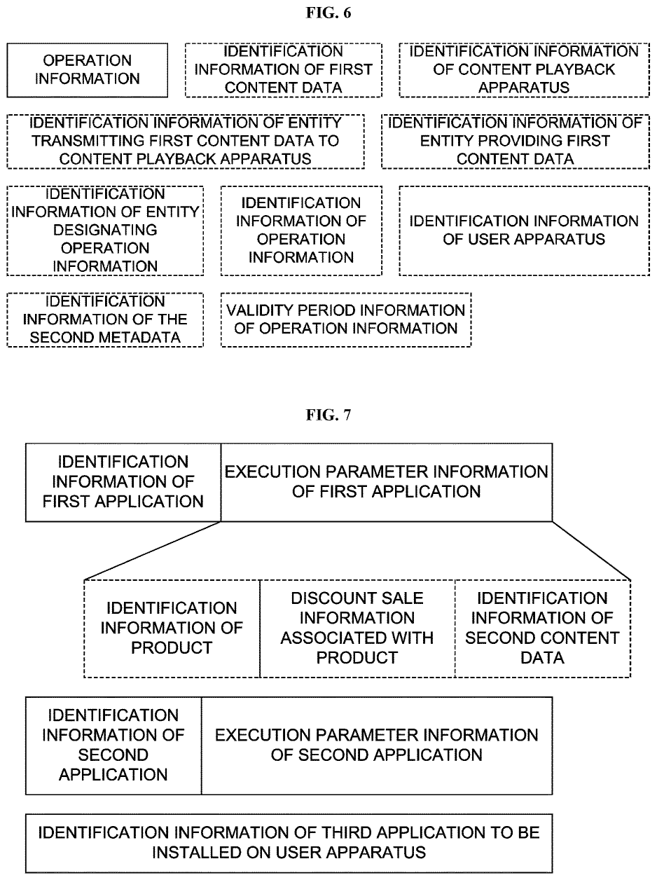

FIG. 6 is a diagram schematically illustrating an example of second metadata in the data processing method according to the first embodiment of the technique of the present disclosure.

In FIG. 6, solid lines indicate mandatory information that is required to be included (i.e., in the example of FIG. 6, operation information), and dashed lines indicate optional information that may be additionally included.

Referring to FIG. 6, the second metadata may include at least operation information. The second metadata may further include one or more of identification information of the second metadata, identification information of the first content data, identification information of the content playback apparatus 200, identification information of an entity transmitting the first content data to the content playback apparatus 200, identification information of an entity providing the first content data, identification information of an entity designating the operation information, identification information of the operation information, identification information of the user apparatus 300, and validity period information of the operation information.

The identification information of the second metadata is unique information assigned to the second metadata. For example, the processing circuitry 130 may generate the identification information for the second metadata and assign the generated identification information to the second metadata. The identification information of the second metadata may be used as reference information in association with execution information to be described later.

The identification information of the user apparatus 300 is unique information assigned to the user apparatus 300, and may include, for example, network information of the user apparatus 300 (e.g., an IP address) and/or apparatus identification information thereof.

Since the remaining information may be understood with reference to the above description of the first metadata, a detailed description thereof will be omitted.

The various pieces of information described above may be used as reference information in a case where, for example, the user apparatus 300 generates execution information to be described later. In addition, the various pieces of information described above may also be used as reference information in a case where, for example, the data processing apparatus 100 transmits execution information, to be described later, to any one of the content transmission apparatus 400, the content providing apparatus 500, and the operation information designation apparatus 600. In other words, the various pieces of information described above may be included in the execution information as reference information that more specifically indicates a circumstance in which the operation information has been executed. Accordingly, such information may be used in generating additional information based on the execution information. For example, the various pieces of information described above may be used to generate statistical information regarding execution information associated with operation information transmitted through a specific system operator (SO) or program provider (PP).

FIG. 7 is a diagram schematically illustrating an example of operation information in the data processing method according to the first embodiment of the technique of the present disclosure.

As shown in FIG. 7, the operation information may include identification information of a first application designated to be executed by the user apparatus 300 in association with the first content data, and execution parameter information for executing the first application.

The first application may be, for example, an electronic commerce (e-commerce) application or a video content providing application.

For example, in a case where the first application is an e-commerce application, the execution parameter information of the first application may include one or more of identification information of a product to be provided through the first application, or discount sale information associated with the product.

For example, in a case where the first application is a video content providing application, the execution parameter information of the first application may include identification information of second content data to be provided through the first application.

Referring to FIG. 7, the operation information may include identification information of a first application designated to be executed by the user apparatus 300 in association with the first content data and execution parameter information of the first application. The operation information may further include identification information of a second application designated to be executed in place of the first application in a case where the first application is not executable on the user apparatus 300 and execution parameter information of the second application.

Since the execution parameter information of the second application may be substantially similar to the execution parameter information of the first application, a detailed description thereof will be omitted.

The operation information may further include identification information of a third application to be installed on the user apparatus 300 in association with the first content data. For example, in a case where a third application is newly developed and promoted, the operation information may indicate that the third application is to be installed on the user apparatus 300. In this case, the operation information may include the identification information of the third application to be installed on the user apparatus 300 in association with the first content data. In a case where the third application has already been installed on the user apparatus 300, the user apparatus 300 may ignore the operation information.

Referring back to FIG. 1, in S170, the processing circuitry 130 may transmit the second metadata generated in step S150 to the user apparatus 300.

The user apparatus 300 may operate based on the second metadata. That is, the user apparatus 300 may execute the first application to provide product information using execution parameter information of the first application, such as identification information of a product to be provided through the first application and discount sale information associated with the product. Alternatively, the user apparatus 300 may execute the first application to provide second content data using, for example, identification information of the second content data. In a case where the first application is not executable, for example, when the first application is not installed on the user apparatus 300, the user apparatus 300 may execute the second application to provide product information or second content data in a manner similar to that described above. The user apparatus 300 may also install the third application.

The above-described operation of the user apparatus 300 may be preferably performed after an authorization message, such as “Would you like to receive product information?”, is displayed on the user apparatus 300 and a user authorization response is received in response thereto.

Meanwhile, as illustrated in FIG. 1, in a case where it is determined in step S130 that the content playback apparatus 200 and the user apparatus 300 belong to the same network group, the processing circuitry 130 may transmit identification information of the user apparatus 300 to the content playback apparatus 200 (step S190).

For example, the content playback apparatus 200 may request authorization for providing the second metadata to the user apparatus 300 based on identification information of the user apparatus 300. More specifically, the content playback apparatus 200 may display an authorization guidance message in addition to first content currently being displayed, and may receive an authorization response to the authorization guidance message. For example, in a case where the identification information of the user apparatus 300 is “AA,” the authorization guidance message may be displayed in a format such as, “Would you like to view information regarding a product related to the currently displayed content using the AA smart phone? Please press a yellow button to approve, and press a red button to reject.”

When the content playback apparatus 200 receives an authorization response, for example, a signal indicating that the yellow button has been pressed in the above-described example, the content playback apparatus 200 may transmit the authorization response to the data processing apparatus 100. The processing circuitry 130 may then receive, from the content playback apparatus 200, the authorization response for providing the second metadata to the user apparatus 300 (step S210).

Step S150 and/or step S170 may be performed after step S210. In other words, step S150 and/or step S170 may be performed only in response to receiving the authorization response.

### Second Embodiment

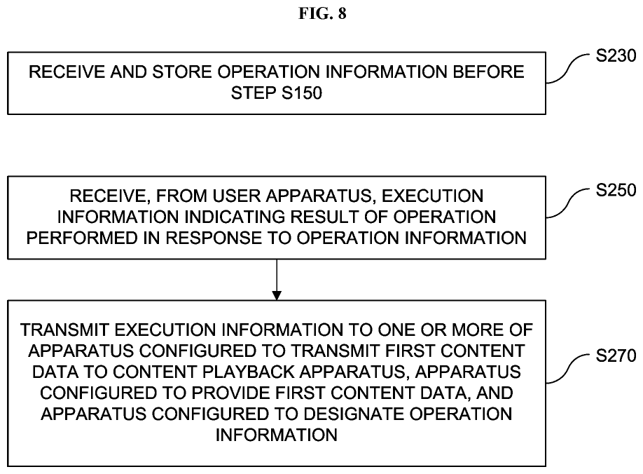

FIG. 8 is a diagram schematically illustrating an example of a data processing method according to a second embodiment of the technique of the present disclosure. The data processing method according to the second embodiment described with reference to FIG. 8 may be performed in addition to the data processing method according to the first embodiment described above.

The processing circuitry 130 may receive and store operation information before step S150 (step S230).

That is, in the first embodiment described above, the first metadata may include at least identification information of the operation information, and may further include the operation information.

In a case where the first metadata does not include the operation information in the first embodiment, the processing circuitry 130 may receive and store the operation information based on the identification information of the operation information.

For example, the processing circuitry 130 may receive operation information corresponding to the identification information of the operation information from the operation information designation apparatus 600 and store the operation information.

The operation information received and stored in step S230 may be used, for example, to generate the second metadata in step S150.

Further, the processing circuitry 130 may receive, from the user apparatus 300, execution information indicating a result of an operation performed in response to the operation information (step S250), and may transmit the execution information to one or more of the content transmission apparatus 400, the content providing apparatus 500, and the operation information designation apparatus 600 (step S270).

### Other Embodiments

While the technique of the present disclosure is described in detail by way of the embodiments described above, the technique of the present disclosure is not limited thereto and it will be apparent to those skilled in the art that the technique of the present disclosure may be modified in various ways without departing from the scope thereof.

For example, according to another aspect of the technique of the present disclosure, there is provided the data processing apparatus 100 including the processing circuitry 130 configured to perform: (a) receiving, from the content playback apparatus 200, first metadata pre-designated for first content data that is signal-processed and played back by the content playback apparatus 200; (b) determining whether the content playback apparatus 200 and the user apparatus 300 are included in a same network group; (c) generating, based on the first metadata, second metadata including at least operation information indicating an operation to be performed by the user apparatus 300 in association with the first content data in case it is determined in (b) that the content playback apparatus 200 and the user apparatus 300 are included in the same network group; and (d) transmitting the second metadata to the user apparatus 300. Further, the first metadata includes at least identification information of the operation information.

Other technical features of the data processing method according to the technique of the present disclosure may also be applied in a similar way to the data processing apparatus 100 according to the technique of the present disclosure.

Accordingly, the exemplary embodiments disclosed herein are not used to limit the technical idea of the present disclosure, but to explain the present disclosure, and the scope of the technical idea of the present disclosure is not limited by those embodiments. Therefore, the scope of protection of the present disclosure should be construed as defined in the following claims, and all technical ideas that fall within the technical idea of the present disclosure are intended to be embraced by the scope of the claims of the present disclosure.

### INDUSTRIAL APPLICABILITY

According to the technique of the present disclosure, second metadata including at least operation information indicating an operation to be performed by a user apparatus may be generated based on first metadata designated for first content data that is signal-processed and played back by a content playback apparatus, and the generated second metadata may be transmitted to the user apparatus. Accordingly, without requiring complicated operations, information associated with the first content data being played back by the content playback apparatus may be conveniently provided to a user through the user apparatus based on the second metadata. For example, the user may easily identify and purchase a product designated for the first content data through the user apparatus based on the second metadata, or may easily install, on the user apparatus, an application designated for the first content data based on the second metadata. That is, according to the technique of the present disclosure, operations to be performed by the user apparatus, for example, provision of product information or provision of second content data, may be more specifically controlled in terms of which application is used or which application is installed.

<Explanation of Reference Symbols>

100: data processing apparatus
130: processing circuitry
200: content playback apparatus
300: user apparatus
400: content transmission apparatus
500: content providing apparatus
600: operation information designation apparatus

What is claimed is:

1. A data processing method to be performed by a data processing apparatus, the method comprising:
(a) receiving, from a content playback apparatus, first metadata pre-designated for first content data that is signal-processed and played back by the content playback apparatus;
(b) determining whether the content playback apparatus and a user apparatus are included in a same network group;
(c) generating, based on the first metadata, second metadata including at least operation information indicating an operation to be performed by the user apparatus in association with the first content data in case it is determined in (b) that the content playback apparatus and the user apparatus are included in the same network group; and
(d) transmitting the second metadata to the user apparatus,
wherein the first metadata includes at least identification information of the operation information.

2. The method of claim 1, wherein (b) comprises:
(b-1) determining whether the content playback apparatus and the user apparatus are included in the same network group based on network information of the content playback apparatus and network information of the user apparatus.

3. The method of claim 2, wherein the network information of the content playback apparatus is obtained in (a).

4. The method of claim 2, wherein the network information of the user apparatus is transmitted from the user apparatus at predetermined intervals, transmitted from the user apparatus whenever the network information of the user apparatus is changed, or transmitted from the user apparatus in response to a predetermined request for the network information.

5. The method of claim 2, wherein the network information of the content playback apparatus includes identification information of a first network apparatus to which the content playback apparatus is connected,
the network information of the user apparatus includes identification information of a second network apparatus to which the user apparatus is connected, and
(b-1) comprises determining that the content playback apparatus and the user apparatus are included in the same network group if the identification information of the first network apparatus is identical to the identification information of the second network apparatus, and determining that the content playback apparatus and the user apparatus are not included in the same network group if the identification information of the first network apparatus is not identical to the identification information of the second network apparatus.

6. The method of claim 1, further comprising:
(e) transmitting identification information of the user apparatus to the content playback apparatus in case it is determined in (b) that the content playback apparatus and the user apparatus are included in the same network group.

7. The method of claim 6, further comprising:
(f) after (e), receiving, from the content playback apparatus, an authorization response for providing the second metadata to the user apparatus,
wherein at least one of (c) or (d) is performed after (f).

8. The method of claim 1, further comprising:
(g) before (c), receiving and storing the operation information.

9. The method of claim 1, further comprising:
(h) receiving, from the user apparatus, execution information indicating a result of an operation performed in response to the operation information; and
(i) transmitting the execution information to one or more of an apparatus configured to transmit the first content data to the content playback apparatus, an apparatus configured to provide the first content data, and an apparatus configured to designate the operation information.

10. The method of claim 1, wherein the first metadata further includes one or more of identification information of the first content data, identification information of the content playback apparatus, identification information of an entity transmitting the first content data to the content playback apparatus, identification information of an entity providing the first content data, identification information of an entity designating the operation information, the operation information, and validity period information of the operation information.

11. The method of claim 1, wherein the first metadata is transmitted from the content playback apparatus to the data processing apparatus in a case where playback of the first content data begins.

12. The method of claim 1, wherein the second metadata further includes one or more of identification information of the second metadata, identification information of the first content data, identification information of the content playback apparatus, identification information of an entity transmitting the first content data to the content playback apparatus, identification information of an entity providing the first content data, identification information of an entity designating the operation information, identification information of the operation information, identification information of the user apparatus, and validity period information of the operation information.

13. The method of claim 1, wherein the operation information includes identification information of a first application designated to be executed by the user apparatus in association with the first content data, and execution parameter information of the first application.

14. The method of claim 13, wherein the execution parameter information of the first application includes one or more of identification information of a product to be provided through the first application, discount sale information associated with the product, and identification information of second content data to be provided through the first application.

15. The method of claim 1, wherein the operation information includes identification information of a first application designated to be executed on the user apparatus in association with the first content data, execution parameter information of the first application, identification information of a second application designated to be executed in place of the first application in a case where the first application is not executable on the user apparatus, and execution parameter information of the second application.

16. The method of claim 1, wherein the operation information includes identification information of a third application to be installed on the user apparatus in association with the first content data.

17. A data processing apparatus comprising
a processing circuitry configured to perform:
(a) receiving, from a content playback apparatus, first metadata pre-designated for first content data that is signal-processed and played back by the content playback apparatus;
(b) determining whether the content playback apparatus and a user apparatus are included in a same network group;
(c) generating, based on the first metadata, second metadata including at least operation information indicating an operation to be performed by the user apparatus in association with the first content data in case it is determined in (b) that the content playback apparatus and the user apparatus are included in the same network group; and
(d) transmitting the second metadata to the user apparatus,
wherein the first metadata includes at least identification information of the operation information.
